(19) United States
(12) Patent Application Publication
(10) Pub. No.: US 2022/0208403 A1
(43) Pub. Date: Jun. 30, 2022

(54) SYSTEM AND METHOD FOR DEPLOYING AND OPERATING A NUCLEAR REACTOR SYSTEM

(71) Applicant: Radiant Industries, Incorporated, El Segundo, CA (US)

(72) Inventors: Doug Bernauer, El Segundo, CA (US); Armand Eliassen, El Segundo, CA (US)

(21) Appl. No.: 17/566,917

(22) Filed: Dec. 31, 2021

Related U.S. Application Data
(60) Provisional application No. 63/133,188, filed on Dec. 31, 2020.

(51) Int. Cl. G21C 17/00; G21C 19/36; H02J 3/00

(52) U.S. Cl. CPC G21C 17/00; H02J 3/00; G21C 19/36

(57) ABSTRACT

One variation of a method for deploying a nuclear reactor system includes: constructing a tunnel at a particular location; and installing the nuclear reactor, loaded with a first core assembly, within the tunnel. The method further includes, during an operating period: in response to detecting a high-energy demand period: triggering operation of the nuclear reactor at a first capacity, directing a first portion of energy output to a charging station for charging electric vehicles, and directing a second portion, less than the first portion, of energy output to a gas sequestration subsystem; and, in response to detecting a low-energy demand period, triggering operation of the nuclear reactor at a second capacity less than the first capacity, directing a third portion of energy, less than the first portion, output to the charging station, and directing a fourth portion of energy, exceeding the second portion, output to the gas sequestration subsystem.

### CROSS-REFERENCE TO RELATED APPLICATIONS

This Application claims the benefit of U.S. Provisional Application No. 63/133,188, filed on 31 Dec. 2020, which is incorporated in its entirety by this reference.

This Application is related to U.S. patent application Ser. No. 17/398,777, filed on 10-Aug.-2021, and U.S. patent application Ser. No. 17/398,762, filed on 10-Aug.-2021, each of which is incorporated in its entirety by this reference and each of which claim the benefit of U.S. Provisional Application No. 63/064,308, filed on 11-Aug.-2020, and U.S. Provisional Application No. 63/066,088 filed on 14 Aug. 2020, each of which is incorporated in its entirety by this reference.

### TECHNICAL FIELD

This invention relates generally to the field of nuclear power and more specifically to a new and useful nuclear reactor system and method for deploying a nuclear reactor system in the field of nuclear power.

### BRIEF DESCRIPTION OF THE FIGURES

FIG. 1 is a schematic representation of a method;

FIG. 2 is a schematic representation of the method;

FIG. 3 is a schematic representation of the method;

FIG. 4 is a schematic representation of the method

FIGS. 5A and 5B are schematic representations of the method; and

FIG. 6 is a schematic representation of a system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

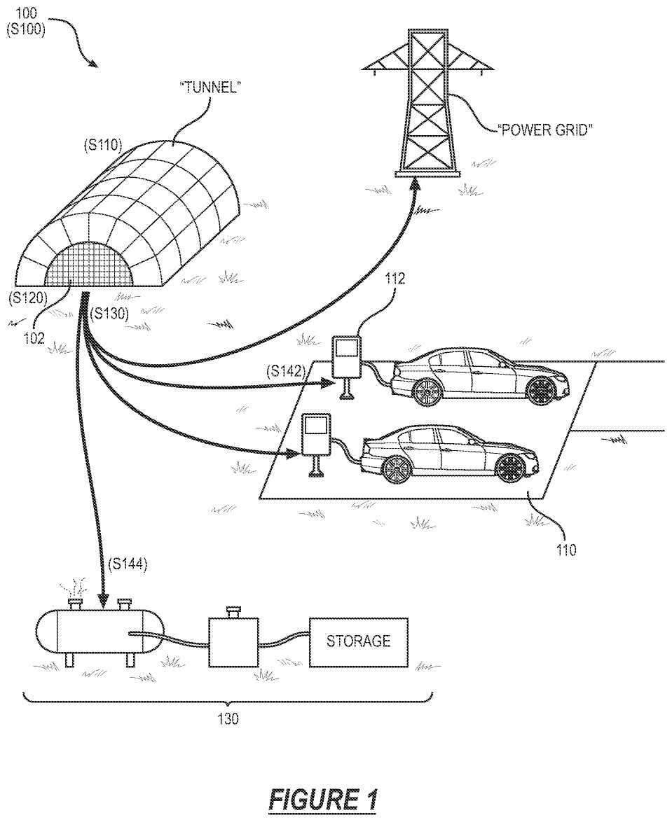

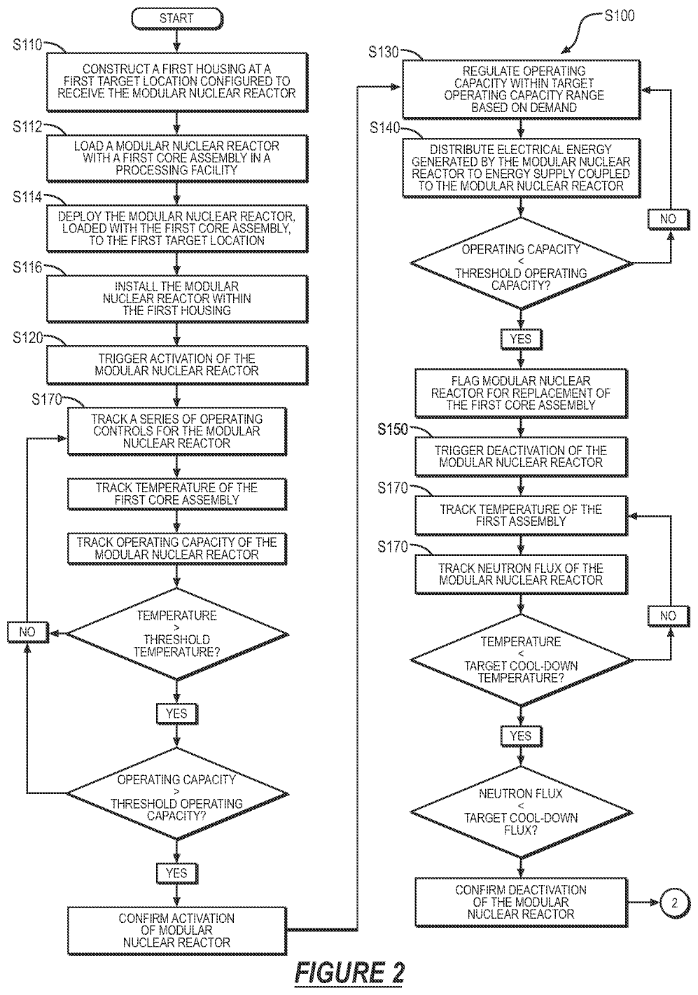

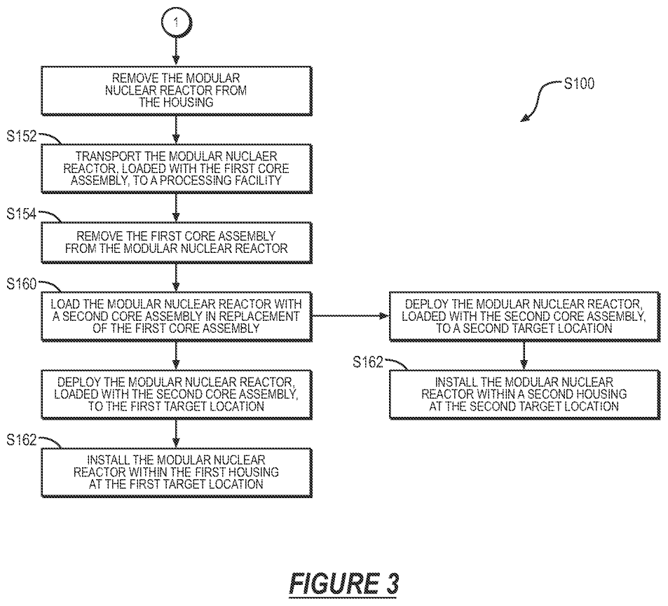

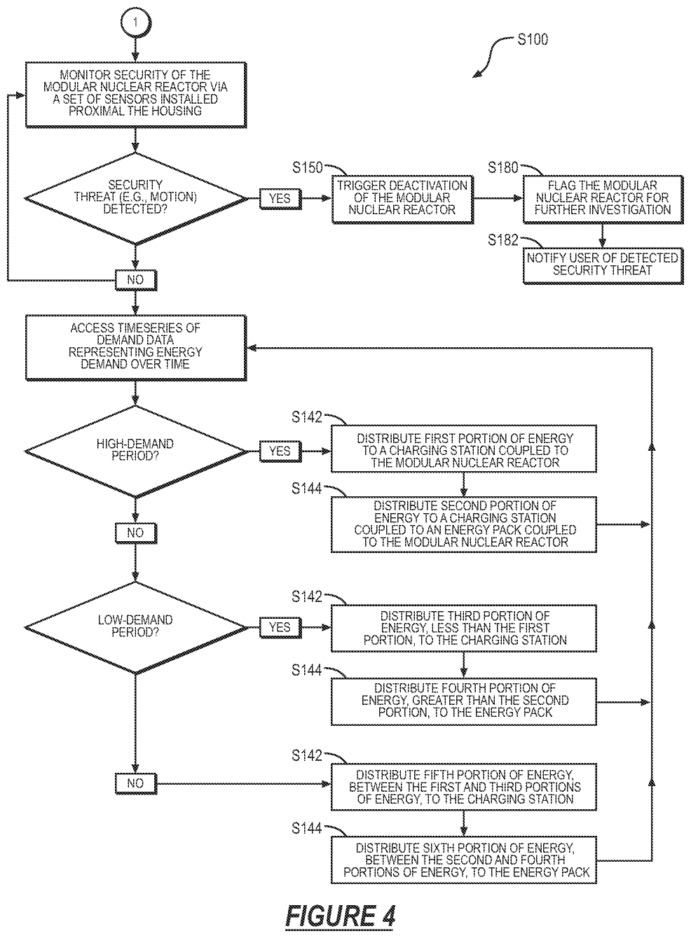

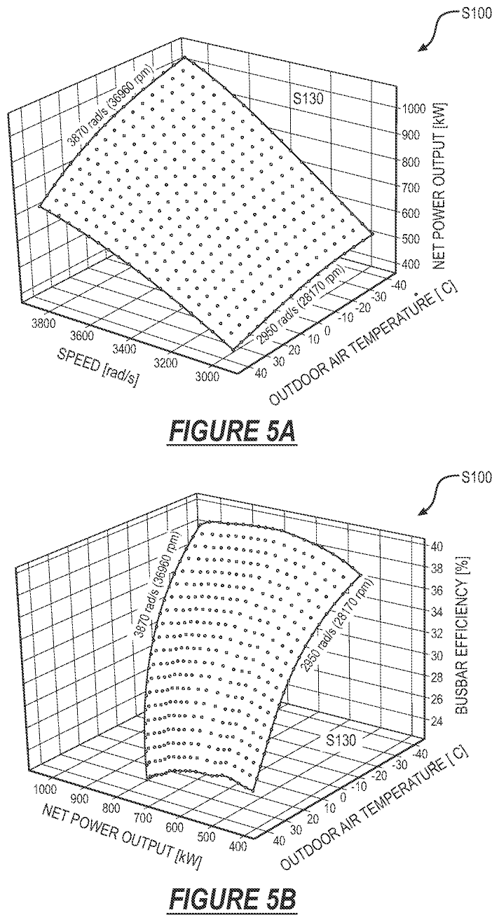

As shown in FIGS. 1-4, 5A, and 5B, a method S100 for deploying a nuclear reactor system 100 includes, during a first installation period: at a processing facility, loading a modular nuclear reactor 102 with a first core assembly, in a set of core assemblies, the modular nuclear reactor 102 configured to receive replacement core assemblies over time in Block S112; at a first target location remote from the processing facility, constructing a housing configured to receive the modular nuclear reactor 102 in Block Silo; and installing the modular nuclear reactor 102, loaded with the first core assembly, within the housing at the first target location in Block S116. The method S100 further includes, during a first startup period succeeding the first installation period, triggering activation of the modular nuclear reactor 102 in Block S120, and, in response to triggering activation of the modular nuclear reactor 102: tracking a temperature of the first core assembly in Block S170; tracking an operating capacity of the modular nuclear reactor 102 in Block S170; and, in response to the temperature exceeding a target setup temperature and the operating capacity exceeding a threshold operating capacity, confirming activation of the modular nuclear reactor 102.

The method S100 further includes, during a first live period succeeding the first startup period, in response to confirming activation of the modular nuclear reactor 102: regulating the operating capacity of the modular nuclear reactor 102 within a target operating capacity range based on demand for energy generated by the modular nuclear reactor 102 in Block S130; distributing electrical energy generated by the modular nuclear reactor 102 to an energy supply coupled to the modular nuclear reactor 102 in Block S140; and, in response to the operating capacity falling below the threshold operating capacity, flagging the modular nuclear reactor 102 for replacement of the first core assembly. The method S100 further includes, during a first cool-down period, in response to flagging the modular nuclear reactor 102 for replacement of the first core assembly, triggering deactivation of the modular nuclear reactor 102 in Block S150, and, in response to triggering deactivation of the modular nuclear reactor 102: tracking the temperature of the first core assembly in Block S170; tracking a neutron flux of the modular nuclear reactor 102 in Block S170; and, in response to the temperature falling below a target cool-down temperature and in response to the neutron flux falling below a target cool-down flux, confirming deactivation of the modular nuclear reactor 102.

In one variation, the method S100 further includes: during a first interim period succeeding the first cool-down period, in response to confirming deactivation of the modular nuclear reactor 102: removing the modular nuclear reactor 102, loaded with the first core assembly, from the housing and transporting the modular nuclear reactor 102 from the first target location to the processing facility in Block S152; and, at the processing facility, removing the first core assembly from the modular nuclear reactor 102 in Block S154. In this variation, the method S100 can further include, during a second installation period succeeding the first interim period, loading the modular nuclear reactor 102 with a second core assembly, in the set of core assemblies, in replacement of the first core assembly in Block S160.

Additionally, in this variation, the method S100 can further include: transporting the modular nuclear reactor 102, loaded with the second core assembly, from the processing facility to the first target location; and installing the modular nuclear reactor 102, loaded with the second core assembly, within the housing at the first target location in Block S162. In another variation, the method S100 further includes: transporting the modular nuclear reactor 102, loaded with the second core assembly, from the processing facility to a second target location; and installing the modular nuclear reactor 102, loaded with the second core assembly, within a second housing at the second target location in Block S162.

In one variation, the method S100 further includes, during the first installation period, deploying the modular nuclear reactor, loaded with the first core assembly, to the target location in Block S114.

One variation of the method S100 includes: constructing a tunnel configured to receive a nuclear reactor 102 at a particular location in Block Silo; and, at a first time, installing the nuclear reactor 102 including a first core assembly in the tunnel in Block S112. The method further includes, during a first operating period succeeding the first time and defining a set duration, in response to detecting a high-energy demand period: triggering operation of the nuclear reactor 102 at a first capacity in Block S130; directing a first portion of energy output to a charging station 110 for charging electric vehicles in Block S142; and directing a second portion of energy output to a gas sequestration subsystem 130, the second portion less than the first portion in Block S144. The method further includes, during the first operating period, in response to detecting a low-energy demand period: triggering operation of the nuclear reactor 102 at a second capacity less than the first capacity in Block S130; directing a third portion of energy output to the charging station 110, the third portion less than the first portion in Block S142; and directing a fourth portion of energy output to the gas sequestration subsystem 130, the fourth portion greater than the second portion in Block S144.

In one variation, the method S100 further includes, in response to expiration of the set duration: shutting off the nuclear reactor 102 in Block S150; transferring the nuclear reactor 102 from the tunnel at the first location to a processing facility at a secondary location, distinct from the first location, in Block S152, for replacement of the first core assembly with a second core assembly in Block S160; and, at a second time succeeding the first operating period, reinstalling the nuclear reactor 102 including the second core assembly in the tunnel in Block S162.

### 2. Nuclear Reactor System

As shown in FIG. 1, a nuclear reactor system 100 includes: a modular nuclear reactor 102 semi-buried in a tunnel 114 configured to house the modular nuclear reactor 102; a charging station 110 including a set of charging units 112 coupled to the modular nuclear reactor 102 and configured to receive energy output by the modular nuclear reactor 102 to transiently charge electric vehicles; an energy storage pack 120 coupled to the modular nuclear reactor 102 and configured to receive excess energy output by the modular nuclear reactor 102 for storage; and a gas sequestration subsystem 130 coupled to the modular nuclear reactor 102 and configured to receive energy output by the modular nuclear reactor 102 to capture secondary gases.

One variation of the nuclear reactor system 100 includes: a modular nuclear reactor 102 installed within a housing (e.g., a tunnel) constructed at a target location; a charging station 110 including a set of charging units 112, each charging unit 112, in the set of charging units 112, coupled to the modular nuclear reactor 102 and configured to supply energy received from the modular nuclear reactor 102 to electrical vehicles coupled to the charging unit 112; an energy storage pack 120 coupled to the modular nuclear reactor 102 and configured to store excess energy output by the modular nuclear reactor 102. In this variation, the nuclear reactor system can also include a gas sequestration subsystem 130 coupled to the modular nuclear reactor 102 and configured to receive excess energy output by the modular nuclear reactor 102 and capture secondary gases (e.g., hydrogen, nitrogen, carbon dioxide) from ambient air at the target location.

In one variation, as shown in FIG. 1, the nuclear reactor system 100 includes a set of modular nuclear reactors 102 configured to supply power to a set of electrical vehicle charging stations.

### 3. Applications

Generally, as shown in FIGS. 1-6, the nuclear reactor system 100 (hereinafter the “system”) includes: a modular nuclear reactor 102 (e.g., a high-temperature gas, modular (micro)reactor) including a lift-out, replaceable reactor core assembly configured for replacement as a singular unit; a charging station 110 including a set of charging units 112 configured to receive electrical energy output by the nuclear reactor 102 to transiently charge electric vehicles; and an energy storage pack configured to store excess electrical energy output by the nuclear reactor 102.

In particular, the system 100 includes a nuclear reactor 102 including a reactor vessel 210 and a power generation system—such as arranged in a singular module chassis (e.g., a 20-foot-long high-cube shipping container)—configured to convert thermal energy in a high-temperature working fluid (e.g., helium), received from the reactor vessel 210, into electrical energy. The reactor vessel 210 is configured to receive replacement core assemblies over time, such as once per five- or ten-year period over multiple decades.

The system 100 can be deployed to any location—independent of access to a power grid—to enable rapid, emission-free charging of electric vehicles via nuclear power generation, thereby enabling access to electric charging in both higher population density regions (e.g., major cities, suburbs) and lower population density regions (e.g., remote and/or rural regions). The system 100 can be configured to continuously operate and to generate substantial amounts of power, such that a vehicle can be fully charged within minutes. By generating power completely independent of the power grid—which relies heavily on coal and natural gas for power generation—the system 100 enables emission-free charging of electrical vehicles.

Before the nuclear reactor 102 is deployed to a particular location—such as along an interstate highway for charging electric vehicles—the nuclear reactor 102 is assembled with a complete core assembly. At the particular location, the system 100—including the charging station 110 and a housing (i.e., the tunnel) for the nuclear reactor 102—can be constructed. Once the nuclear reactor 102 is activated, the nuclear reactor 102 can operate continuously over a particular duration (e.g., five years, ten years after initial deployment). At the end of this duration, the nuclear reactor 102 can be removed from the housing and returned to a processing facility for replacement of the core assembly. Once the core assembly is replaced, the nuclear reactor 102 can be redeployed to the particular location and reinstalled within the housing to provide near-continuous power for an additional five or ten years. The system 100 can therefore continue generating power over multiple refueling cycles of the nuclear reactor 102, thereby limiting costs associated with constructing and maintaining the system 100.

The system 100 can be configured to adjust power output as demand for electricity fluctuates over a given operating period. For example, the system 100 can be configured to increase an operating capacity of the nuclear reactor 102 during periods of high-traffic (e.g., during rush hour) and to decrease the operating capacity during periods of low-traffic (e.g., overnight). Furthermore, the system 100 can include a gas sequestration subsystem 130 configured to receive electrical energy output by the nuclear reactor 102 during periods of low energy demand at the charging station 110. During periods of low energy demand, the system 100 can: operate the nuclear reactor 102 at a minimum capacity (e.g., 5% capacity) in order to limit thermal cycling of reactor components; and divert excess energy to the gas sequestration subsystem 130 in order to generate secondary products, such as fuels or industrial chemicals—rather than waste this excess energy—and thus support other alternative fuel vehicles and/or other local industries.

For example, the system 100 can include a gas sequestration subsystem 130 configured to capture nitrogen and water from ambient air to generate hydrogen gas. The gas sequestration subsystem 130 can include a storage tank configured to store the generated hydrogen gas and a fueling station coupled to the storage tank. Therefore, in this example, the system 100 can enable both charging of electric vehicles and fueling of hydrogen vehicles. In another example, the system 100 can include a gas sequestration subsystem 130 configured to capture carbon dioxide from ambient air and to store this captured carbon dioxide, thereby enabling the system 100 to operate as a carbon-negative process. Additionally and/or alternatively, if available, the system 100 can direct excess power output by the nuclear reactor 102 to the power grid.

Therefore, the system 100 can enable a vehicle charging station to be rapidly constructed (e.g., within five days of new site selection) with no requirements for extant infrastructure and then loaded with a pre-assembled, pre-fueled, pre-sealed, and fully-operational nuclear reactor 102. The nuclear reactor 102 can also be removed from the charging station once its nuclear fuel is spent (e.g., five years after deployment, ten years after deployment), returned to a remote processing facility, and reloaded with new fuel. The spent fuel removed from the nuclear reactor 102 can also be handled at this remote processing facility rather than at the electrical vehicle charging station, thereby separating and isolating nuclear waste containing from the electrical vehicle charging station and away from the public. Thus, the system 100 can be quickly deployed to form a network of electrical vehicle charging stations along any road network to support rapid charging of electrical vehicles. These electrical vehicle charging stations can also divert excess energy from their nuclear reactors 102 to generate alternative fuels (e.g., hydrogen, ammonia, syngas, etc.) and thus also support refueling of alternative-fuel vehicles without necessitating any fuel transportation—such as other than refueling of the nuclear reactor 102 once per decade.

### 4. Nuclear Reactor

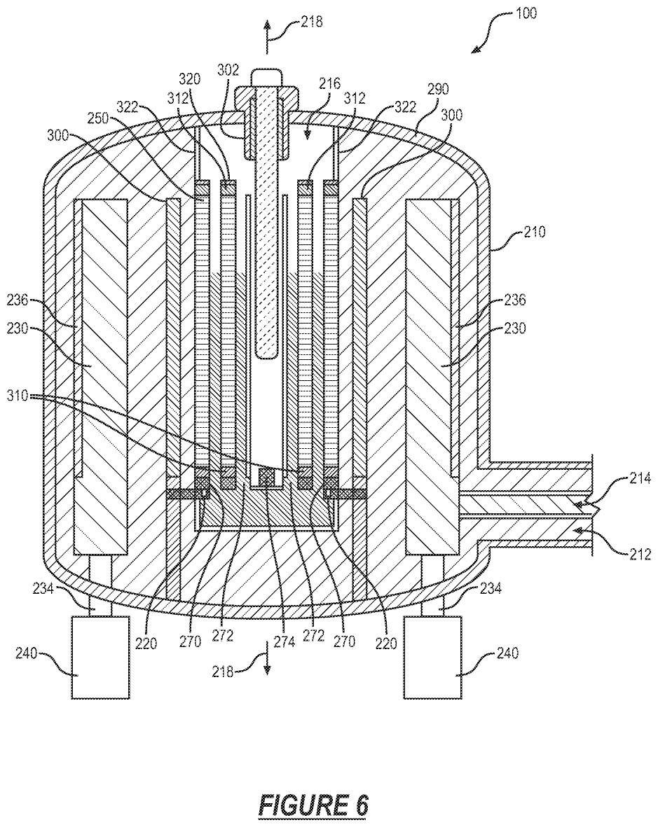

As shown in FIGS. 1 and 6, the system 100 includes a modular nuclear reactor 102 (or “nuclear reactor 102”) including: a reactor vessel 210; a vessel head 290; a core assembly; and a set of control drums 230. The reactor vessel 210: defines a core receptacle 216 including a set of locating datums 218; includes a vessel inlet 212 and a vessel outlet 214 coaxial with the vessel inlet 212 and intersecting the core receptacle 216; and locates the set of control drums 230 about the core receptacle 216 over a vertical length between the vessel inlet 212 and the vessel outlet 214. The core assembly includes: a moderating core structure 252 that defines a set of vertical flow channels 256 configured to pass a working fluid, a set of fuel channels configured to locate nuclear fuel, and/or a set of vertical poison channels configured to locate nuclear poison; a set of locating features 258 configured to mate with the locating datums 218 in the reactor vessel 210 to transiently locate and constrain the moderating core structure 252 in the core receptacle 216 and along a flow path between the vessel inlet 212 and the vessel outlet 214; and a lift-out support plate 270 configured to vertically support the moderating core structure 252 during insertion of the moderating core structure 252 into the reactor receptacle at a first time and during removal and replacement of the moderating core structure 252 from the reactor receptacle at a second time. The vessel head 290 is configured to transiently install on the reactor vessel 210 over the core assembly to seal the core assembly within the reactor vessel 210.

The nuclear reactor 102 further includes a power generator (e.g., a gas turbine and generator; a thermoelectric generator). A flow path transfers high-temperature working fluid (e.g., liquid helium) from the reactor vessel 210 to the power generator, which extracts heat from this high-temperature working fluid and converts this heat into electricity. The flow path then returns low(er)-temperature working fluid from the power generator back to the reactor vessel 210, when fuel in the core assembly reheats this working fluid before the working fluid returns again to the power generator.

In one example implementation, as shown in FIG. 6, the modular nuclear reactor 102 can include a reactor vessel 210 including: a core receptacle 216 defining a central axis 218 and including a set of locating datums 220 to receive a nuclear reactor core 250; a set of control drums 230 disposed about a periphery of the core receptacle 216, each control drum 230, in the set of control drums 230, including a solid or monolithic carbon or graphite cylinder with an arcuate channel 234—filled with a neutron poison material, such as a boron carbide plate 236—defined within an angle portion of the curved surface of the cylinder; and a set of control drum actuators 240 coupled to the set of control drums 230 and configured to selectively position each of the set of control drums 230. In the example implementation, the nuclear reactor core 250 can include: a moderating core structure 252—capped by a lower reflector plate 310 and an upper reflector plate 312—including a set of graphite prismatic blocks 254 arranged adjacent a set of vertical flow channels 256 configured to pass a working fluid adjacent the set of graphite prismatic blocks 254 to the vessel outlet 214 and configured to heat the working fluid received through the vessel inlet 212 and transferred through the vessel outlet 214; and a set of locating features 258 configured to mate with the locating datums 220 in the reactor vessel 210 to locate the moderating core structure 252 in the core receptacle 216 and along a flow path between the vessel inlet 212 and the vessel outlet 214. The system 100 can also include a lift-out support plate 270—including a set of apertures 272 aligned with flow channels in the moderating core structure 152 and an integrated connector 274 configured to engage a lift adapter 276—arranged substantially orthogonal to the central axis 218 and configured to: transiently couple with the lift adapter 276 to lower the nuclear reactor core 250 into the reactor vessel 210 along a direction substantially parallel to the central axis 218; and transiently couple with the lift adapter 276 to raise the nuclear reactor core 250 out of the reactor vessel 210 along the direction substantially parallel to the central axis 218. The system 100 can also include a vessel head 290 configured to transiently install on the reactor vessel 210 over the nuclear reactor core 250 to seal the nuclear reactor core 250 within the reactor vessel 210.

The nuclear reactor core 250 can include: a first lower reflector plate 310 configured to reflect incident neutrons back into the moderating core structure 152; a second upper reflector plate 312 configured to reflect incident neutrons back into the moderating core structure 252; and/or a core restraining plate 320 configured to receive a set of upper restraining pins 322 to immobilize and locate the nuclear reactor core 250 within the vessel 210 during operation.

In one variation of the example implementation, the system 100 can include an annular graphite reflector 300 arranged between the set of control drums 230 and the nuclear reactor core 250. In another variation of the example implementation, the modular nuclear reactor 102 can include an emergency neutron poison system 302 that includes a boron carbide elongated member that can be selectively shuttled (e.g., via mechanically threaded actuation) into a central region of the moderating core structure 252 along the central axis 218.

Generally, the nuclear reactor 102 is described herein as a high-temperature gas, modular, mobile, microreactor configured for temporary deployment over a limited period of time, such as five to ten years, before returning to a refueling facility for refueling via replacement of the used core assembly with a new core assembly. However, the system 100 can define a nuclear reactor 102 of any other type, size, or configuration. For example, the system 100 can define a nuclear naval reactor permanently or temporarily installed in a naval vessel and configured for in-field core assembly replacement.

### 4.1 Core Assembly

Before the system 100 is deployed—such as to a location proximal an interstate highway, to a military base, a remote community, or a mineral extraction site—to supply on-demand electrical power (e.g., up to 20 megawatts), a complete core assembly is loaded into the core receptacle 216, located on the locating datums 218, and sealed with a vessel head 290.

For example, the core assembly can include nuclear fuel, neutron poison, a cylindrical moderating core structure 252 (e.g., of graphite) housing the nuclear fuel and neutron poison in a set of discrete channels and defining a set of flow channels, and a lift-out support plate 270 that vertically supports the moderating core structure 252 within the vessel receptacle. During a refueling, the vessel head 290 can be removed from the reactor vessel 210; the core assembly can be removed from the reactor vessel 210 in a single lift event by lifting the lift-out support plate 270 out of the vessel receptacle; a replacement core assembly with new fuel can be lowered into and located within the vessel receptacle; the vessel head 290 can be reinstalled on the reactor vessel 210; and the system 100 can be redeployed to provide near-continuous power for an additional core life in the same or other application.

Therefore, the system 100 can include a reactor vessel 210 configured to receive replacement core assemblies over time. Thus, components within the system 100 exposed to greatest heat and radiation during operation—such as neutron poison, the moderating core structure 252, the lift-out plate, neutron reflectors on the top and bottom of the moderating core structure 252, and a structural casing (or “jacket”) around the moderating core structure 252—are configured for replacement as a singular unit, thereby: reducing the target designed life cycle of these vulnerable elements; lessening mechanical analysis and material performance requirements for these elements; reducing costs of these elements; maintaining better matching of a moderator, neutron poison, and nuclear fuel over the operating lifespan of these elements through the entire operating period of the fuel (e.g., maintaining a consistent active neutron poison to neutron flux ratio for up to a decade of operation of a core assembly); reducing complexity and time allocation for refueling of a nuclear reactor 102 with nuclear fuel; and reducing radiological risk of handling the system 100 and its constituent elements.

For example, because the core assembly is configured to lift out of the vessel receptacle in a single lift event in a singular direction, the core assembly can be removed from the vessel receptacle and replaced with a new core assembly automatically (e.g., autonomously) within a sealed hot cell, and the entire core assembly—including moderator and neutron poison—can be loaded into and sealed within a single spent-fuel container for long-term waste containment in which the neutron poison reduces neutron flux within the spent-fuel container.

### 4.2 Deployment and Operation

The nuclear reactor 102—including the reactor core assembly, power generator, flow path, and controls—can be installed on a chassis and cladded with shielding. For example, the reactor core assembly, power generator, flow path, and controls can be installed in a 20-foot-long high-cube shipping container with shielding, thereby enabling the nuclear reactor 102 to be transported on a flatbed, a trailer, a ship, and/or an aircraft.

For example, the nuclear reactor 102 can be: deployed proximal a major road for supplying power to electrical vehicles; deployed to temporary military installation; placed in a stadium parking lot to temporarily provide additional power during a professional sporting event; or deployed during disaster relief to supply power in locations with damaged infrastructure. Further, the nuclear reactor 102 can be configured for deployment between multiple locations. For example, the nuclear reactor 102 can initially be deployed to a first location proximal a major highway for supplying power to a charging station 110 for electric vehicles. Later, in preparation for a high-traffic, multi-day event (e.g., a music festival) at a second location, the nuclear reactor 102 can be moved from the first location to the second location for supplying power for a duration of this event. The nuclear reactor 102 can then be moved back to the first location after the event.

The nuclear reactor 102 can therefore be deployed and operated (at variable power outputs based on control drum positions over time) over an extended duration of time, such as ten years. Once the neutron flux and/or the power output of the system 100 drops below a threshold, the nuclear reactor 102 can be shipped to a processing facility for replacement of the spent core assembly with a new or refurbished core assembly.

### 4.2.1 Installation & Startup Period

The nuclear reactor 102 can be deployed to a target location for generating and supplying energy at the target location. For example, the entire system 100 can be installed in one or two 20-foot-long high-cube shipping containers with shielding, thereby enabling the system 100 to be transported on a flatbed, a trailer, a ship, and/or an aircraft. Due to its mobility, the system 100 can be: deployed to a temporary military installation; deployed to a remote village; deployed to a location hosting an event (e.g., a music or art festival, a sporting event) to supply power used at a remote mineral extraction site; or deployed during disaster relief to supply power to locations with damaged infrastructure.

In one implementation, during an installation period, the modular nuclear reactor 102—located in a processing facility—can be loaded with a core assembly, in a set of core assemblies, in preparation for deployment to a particular target location. Once loaded with the core assembly, the modular nuclear reactor 102 can be transported (e.g., via truck, ship, and/or aircraft) to the target location. At the target location (e.g., proximal a major roadway, proximal a location of a major event), a housing (e.g., a tunnel) configured to receive the modular nuclear reactor 102 can be constructed. Once construction of the housing is complete, the modular nuclear reactor 102—loaded with the core assembly—can be installed within this housing at the target location.

Additionally, in this implementation, once the modular nuclear reactor 102 is installed within the housing, the system 100 can trigger activation of the modular nuclear reactor 102 during a startup period for the modular nuclear reactor 102. For example, the system 100 can activate the modular nuclear reactor 102, thereby initiating heating of the modular nuclear reactor 102—including the working fluid within the modular nuclear reactor 102—and circulation of the working fluid within the modular nuclear reactor 102. During this startup period, the system 100 can: track a temperature of the modular nuclear reactor 102 including the first core assembly and/or working fluid; track an operating capacity of the modular nuclear reactor 102; and/or track a power output and/or neutron flux of the modular nuclear reactor 102. Based on these controls (i.e., temperature, operating capacity, power output, neutron flux), the system 100 can confirm activation of the modular nuclear reactor 102.

For example, during a setup period for a modular nuclear reactor 102, the system 100 can: track a temperature of the first core assembly; and track an operating capacity of the modular nuclear reactor 102. Then, in response to the temperature exceeding a target setup temperature and the operating capacity exceeding a threshold operating capacity (e.g., 5 percent, 10 percent, 30 percent), the system 100 can confirm activation of the modular nuclear reactor 102. Additionally and/or alternatively, in another example, during the setup period for the modular nuclear reactor 102, the system 100 can track a power output of the modular nuclear reactor 102; and, in response to the power output exceeding a threshold power output, confirm activation of the modular nuclear reactor 102.

### 4.2.2 Live Period

In response to confirming activation of the modular nuclear reactor 102, the system 100 can begin regulating generation and distribution of electrical energy by the modular nuclear reactor 102 during a live period (or “operating period”). In particular, the system 100 can be configured to selectively distribute electrical energy generated by the modular nuclear reactor 102 to an energy supply—including one or more energy supply types (e.g., a charging station, an electrical grid, the gas sequestration subsystem)—coupled to the modular nuclear reactor 102.

Further, the system 100 can regulate the operating capacity of the modular nuclear reactor 102 within a target operating capacity range during the live period, such as based on demand for energy generated by the modular nuclear reactor 102. For example, the target operating capacity range can define a threshold operating capacity (i.e., a minimum operating capacity) for the modular nuclear reactor 102 during the live period. In one implementation, the system 100 can regulate the operating capacity of the modular nuclear reactor 102 within a target operating capacity range including operating capacities between 5 percent and 100 percent. In another implementation, the system 100 can regulate the operating capacity of the modular nuclear reactor 102 within a target operating capacity range including operating capacities between 25 percent and 100 percent. In these implementations, by maintaining the operating capacity of the modular nuclear reactor 102 within this target operating capacity range and/or above this threshold operating capacity (e.g., 5 percent, 15 percent, 30 percent), the system 100 can operate continuously and limit thermal cycling of reactor components during the live period.

During the live period, the system 100 can track a series of control data recorded at the modular nuclear reactor 102, including: the operating capacity of the modular nuclear reactor 102; a power output of the modular nuclear reactor 102; and/or a neutron flux of the modular nuclear reactor 102. In one implementation, the system 100 can leverage this series of control data to schedule replacement of the core assembly in the modular nuclear reactor 102. For example, in response to the operating capacity of the modular nuclear reactor 102 falling below a threshold operating capacity during the live period, the system 100 can flag the modular nuclear reactor 102 for replacement of the core assembly. Additionally and/or alternatively, in another example, in response to the power output of the modular nuclear reactor 102 falling below a threshold power output, the system 100 can flag the modular nuclear reactor 102 for replacement of the core assembly. Additionally and/or alternatively, in yet another example, in response to the neutron flux of the modular nuclear reactor 102 falling below a threshold neutron flux, the system 100 can flag the modular nuclear reactor 102 for replacement of the core assembly.

In another implementation, the live period (or “operating period”) can define a target duration (e.g., three days, one week, five years, ten years). In this implementation, the system 100 can automatically trigger deactivation of the modular nuclear reactor 102 in response to expiration of the target duration. Additionally and/or alternatively, in this implementation, the system 100 can leverage a series of control data to schedule replacement of the core assembly in the modular nuclear reactor 102 prior to expiration of the target duration. For example, during a live period of a target duration, the system 100 can track a power output of the modular nuclear reactor 102. Then, during the live period, in response to the power output falling below a threshold power output prior to expiration of the target duration, the system 100 can: flag the modular nuclear reactor 102 for replacement of the core assembly; and/or trigger deactivation of the modular nuclear reactor 102. Alternatively, in this example, in response to the power output remaining above the threshold power output and in response to expiration of the target duration, the system 100 can: flag the modular nuclear reactor 102 for replacement of the core assembly; and/or trigger deactivation of the modular nuclear reactor 102.

### 4.2.3 Cool-Down Period

In response to deactivation of the modular nuclear reactor 102, the system 100 can execute a cool-down period prior to removal of the modular nuclear reactor 102 from the housing and/or transportation of the modular nuclear reactor 102 to a processing facility for replacement of the core assembly. For example, the system 100 can execute a cool-down period of several days, one week, one month, or several months in duration, during which a temperature, power output, and/or neutron flux of the modular nuclear reactor 102 is reduced, thereby enabling safe removal and/or transportation of the modular nuclear reactor 102 from the housing at the target location.

During the cool-down period, the system 100 can continue to track a series of control data, such as: the temperature of the modular nuclear reactor 102, including the core assembly and/or working fluid; a neutron flux of the modular nuclear reactor 102; and/or a power output of the modular nuclear reactor 102. The system 100 can then: confirm deactivation of the modular nuclear reactor 102 based on this series of control data; and/or alert a user or users associated with the modular nuclear reactor 102 that the modular nuclear reactor 102 is deactivated and/or safe for removal from the housing and/or transporting to a processing facility.

For example, during a cool-down period, in response to triggering deactivation of the modular nuclear reactor 102, the system 100 can: track a temperature of the core assembly of the modular nuclear reactor 102; and track a neutron flux of the modular nuclear reactor 102. Then, in response to the temperature falling below a target cool-down temperature, and in response to the neutron flux falling below a target cool-down neutron flux, the system 100 can confirm deactivation of the modular nuclear reactor 102. Additionally in this example, in response to confirming deactivation of the modular nuclear reactor 102, the system 100 can notify a user that the modular nuclear reactor 102 is safe for transporting to the processing facility.

During an interim period succeeding the cool-down period, the modular nuclear reactor 102 can be: removed from the housing; and transported from the target location to a processing facility (e.g., via truck, ship, aircraft). At the processing facility, the core assembly can be removed from the modular nuclear reactor 102 in preparation for installing a new core assembly in the modular nuclear reactor 102.

### 4.3 Remote Refueling

In one implementation, once the nuclear reactor 102 is returned to a processing facility, the nuclear reactor 102 is loaded into a refueling chamber (e.g., a “hot cell”) that replaces a spent core assembly with a new replacement core assembly autonomously and/or via remote manual control, such as within hours of receipt of the nuclear reactor 102.

In one example, the modular nuclear reactor 102 can be loaded with a first core assembly, in a set of core assemblies, prior to deployment to a first target location. Once the modular nuclear reactor 102—loaded with the first core assembly—is returned to the processing facility, the modular nuclear reactor 102 can be loaded with a second core assembly, in the set of core assemblies, in replacement of the first core assembly. This modular nuclear reactor 102—now loaded with the second core assembly—can then be returned to the first target location to continue generating electrical power at this first target location. Alternatively, the modular nuclear reactor 102—loaded with the second core assembly—can be deployed to a second target location distinct from the first target location.

### 5. Modular Nuclear Reactor Highway System

In one implementation, the system 100 can be deployed to a particular location proximal a major roadway (e.g., an interstate highway, a freeway) to enable rapid charging of electric vehicles. In this implementation, units of the system 100 can be deployed to various locations to form a network of small, modular nuclear reactors 102 102 configured to power charging stations 110 for electric vehicles. The system 100 can be deployed to any location—regardless of access to a power grid—thereby increasing access to electric vehicle charging in rural and/or remote areas.

### 5.1 Construction

The system 100 can be deployed to any location regardless of existing electrical infrastructure. For example, the system 100 can be installed along an interstate highway—with no access to a power grid—in the middle of the desert. Once deployed to a particular location, the system 100 can be rapidly installed and readied for operation, such as within five days of breaking ground at the particular location.

In one implementation, a unit of the system 100 can be installed in a particular location (e.g., proximal a major road). Before installing the nuclear reactor 102, a tunnel can be constructed for housing the nuclear reactor 102 at this particular location. This tunnel can be constructed rapidly (e.g., within less than three days) to enable rapid deployment of the system 100. Further, by housing the nuclear reactor 102 within the tunnel, the nuclear reactor 102 can be easily accessed for maintenance and/or removed and replaced for refueling (e.g., for replacement of the nuclear core) at a later time.

For example, to construct the tunnel configured to house the nuclear reactor 102, a pit can be excavated from the earth (e.g., with a backhoe) defining a particular length (e.g., twenty-five feet), a particular width (e.g., ten feet), and a particular depth (e.g., four feet), such that a portion of the nuclear reactor 102 can seat within the pit when installed in the tunnel. Earth removed to form the pit can initially be set aside but preserved.

Once the pit is completely excavated, a truck including a large, arched trailer can be driven into the pit. This trailer can include a set of rollers installed on the trailer, the set of rollers forming a hemispherical archway extending upward and along a length of the trailer. Once the truck is driven into the pit, an array of blocks (e.g., concrete blocks) can be placed over the set of rollers, such that the array of blocks is matched to the hemispherical archway of the set of rollers. Once each of the blocks in the array of blocks is placed, the truck can be driven out of the pit. As the truck drives out, the array of blocks settle and mate to form a self-supporting hemispherical archway of concrete blocks defining a tunnel lining. The loose earth—previously excavated from the pit—can then be transferred over the tunnel lining, thereby further compressing the concrete blocks, thickening walls of the tunnel, and forming the tunnel exhibiting high impact resistance and absorption of nuclear radiation. Therefore, in this example, the tunnel can be constructed within a single day by a small construction crew (e.g., two workers), thereby limiting resources (e.g., labor, fuel, equipment) required for installation of the system 100.

Once the tunnel is complete, a set of nuclear reactors 102 102 can be installed within the tunnel. For example, a single nuclear reactor 102 can be installed within the tunnel. Alternatively, a pair of nuclear reactors 102 102 can be installed within a single tunnel. By installing the nuclear reactor 102 within this semi-buried tunnel, security of the nuclear reactor 102 can be increased by reducing risk due to collision (e.g., automobile, aircraft collision) with the nuclear reactor 102. The nuclear reactor 102 can also be further protected from damage or accidents caused by natural disasters, such as forest fires and/or tornados.

To increase security of the nuclear reactor 102 within the tunnel, a set of barriers can be constructed on each end of the tunnel to restrict entry into the tunnel and/or to shield the nuclear reactor 102 from overhead and ground-based impact. In order to maintain airflow through the tunnel to cool the nuclear reactor 102 during power generation, these barriers can be configured to increase security of the nuclear reactor 102 without hindering airflow through the tunnel. For example, the tunnel can include a first grating installed on a first end of the tunnel and a second grating installed on a second end of the tunnel. These gratings can therefore prevent intruders from gaining access to the nuclear reactor 102 while enabling free airflow through the tunnel for more efficient power generation.

To complete installation of the system 100 at this particular location, a charging station no can be constructed. To construct the charging station 110, a concrete pad can be poured and paved on the ground. A set of charging units 112 can then be installed about the concrete pad, such that an electric vehicle owner may drive her vehicle onto the concrete pad and park at a particular charging unit 112 to charge her electric vehicle.

### 5.2 Security

In one variation, the system 100 can include a security system 100 configured to detect threats to security of the nuclear reactor 102 within the tunnel. In this variation, the system 100 can automatically initiate a safety protocol in response to detecting a threat. For example, the system 100 can be installed at a first geographic location and include a nuclear reactor 102 installed in a tunnel. The system 100 can include a security system 100 including: an array of motion sensors configured to detect motion within an area encompassing the tunnel; and a set of cameras configured to record a set of live video feeds of the area. In this example, in response to detecting motion proximal a first motion sensor, in the array of motion sensors, located at a first entrance of the tunnel, the security system 100 can automatically shut off operation of the nuclear reactor 102.

Further, the system 100 can notify a user (e.g., a security guard, a security administrator) associated with the system 100 to view a first live video feed, in the set of live video feeds, recorded proximal the first entrance of the tunnel at which motion is detected. Additionally and/or alternatively, if the user is at or nearby the geographic location, the system 100 can prompt the user to investigate the area, specifically proximal the first entrance of the tunnel. The user may then verify whether the motion detected by the first sensor is a threat. In this example, in response to receiving verification from the user that the nuclear reactor 102 is secure, the system 100 can trigger reactivation of the nuclear reactor 102. Alternatively, in response to receiving verification from the user that the nuclear reactor 102 is secure, the system 100 can trigger reactivation of the nuclear reactor 102 after a threshold duration.

### 6. Variable Energy Demand

The system 100 can be configured to autonomously adjust power output based on real-time electricity demand from the charging stations 110. In particular, the system 100 can be configured to adjust and/or direct power output based on demand for electric charging.

In one implementation, the system 100 can adjust an operating capacity of the nuclear reactor 102 based on demand for electric charging. In particular, in this implementation, the system 100 can be configured to reduce power output during periods of low electric charging demand; and increase power output during periods of high electric charging demand. In particular, the system 100 can adjust an operating capacity of the nuclear reactor 102 based on demand for electric charging.

In order to limit degradation of internal components of the nuclear reactor 102 (e.g., turbine, helium, steam system 100s), the system 100 can define a minimum operating capacity such that the system 100 operates continuously while appropriately adjusting the operating capacity. For example, the system 100 can implement a minimum operating capacity of five percent in order to limit thermal cycling of reactor components. In this example, rather than shutting off the nuclear reactor 102 during periods of low electric charging demand, the system 100 can automatically set the operating capacity to this minimum operating capacity of five percent.

The system 100 can be configured to adjust operating capacity of the nuclear reactor 102 during predefined periods associated with different levels of electric charging demand (e.g., low demand, high demand).

For example, the system 100 can define: a first operating period corresponding to daytime hours (e.g., between 6:00 AM and 10:00 PM) and associated with high charging demand; and a second operating period corresponding to nighttime hours (e.g., between 10:00 PM and 6:00 AM) associated with low charging demand. In this example, during the first period, the system 100 can automatically set an operating capacity of the nuclear reactor 102 to a standard operating capacity (e.g., twenty percent, fifty percent, ninety percent). Then, in response to expiration of the first period (e.g., at 10:00 PM), the system 100 can automatically trigger the nuclear reactor 102 to reduce the operating capacity from the standard operating capacity to a minimum operating capacity (e.g., five percent, ten percent) for a duration of the second period. The next morning, in response to expiration of the second period (e.g., at 6:00 AM), the system 100 can automatically trigger the nuclear reactor 102 to increase the operating capacity from the minimum operating capacity back to the standard operating capacity.

In another example, the system 100 can automatically adjust operating capacity of the nuclear reactor 102 seasonally. In particular, the system 100 can define: a first operating period corresponding to a “summer” season (e.g., April through October) associated with high charging demand; and a second operating period during a “winter” season (e.g., November through March) associated with low charging demand. In this example, the system 100 can automatically: set an operating capacity of the nuclear to a first operating capacity (e.g., ninety percent) during the first operating period; and set the operating capacity of the nuclear reactor 102 to a second operating capacity (e.g., thirty percent) during the second operating period. Additionally, in this example, the system 100 can define a third operating period corresponding to nighttime hours, such that each night—regardless of the season—the system 100 automatically sets the operating capacity of the nuclear reactor 102 to the minimum operating capacity (e.g., five percent).

Additionally and/or alternatively, the system 100 can be configured to identify periods of varying charging demand to inform adjustment and/or directing of power output by the nuclear reactor 102. For example, in response to detecting ten vehicles at a particular charging station 110, the system 100 can trigger operation of the nuclear reactor 102 at full capacity in order to fully charge each vehicle within a threshold duration. After each of the ten vehicles is fully charged, the system 100 can automatically reduce the operating capacity of the nuclear reactor 102.

Therefore, in this implementation, the system 100 can both: maintain continuous operation of the nuclear reactor 102, thereby limiting damage to internal components of the nuclear reactor 102; and increase efficiency of the nuclear reactor 102 by scaling energy output by the system 100 to the charging station no according to demand, thereby limiting energy waste and increasing a lifespan of the reactor.

In one implementation, in which the system 100 is deployed to a location with access to a power grid, the system 100 can direct excess energy to the power grid. Additionally and/or alternatively, in another implementation, the system 100 can direct excess energy to the gas sequestration subsystem 130 for capture and/or generation of secondary products (e.g., fuels, gases, and/or industrial chemicals).

### 6.1 Gas Sequestration Subsystem

The system 100 can be configured to include a gas sequestration subsystem 130 configured to receive excess power output by the nuclear reactor 102 to capture and/or generate secondary products (e.g., fuels, gases, industrial chemicals).

In one implementation, the gas sequestration subsystem 130 can be configured to generate various fuels and/or industrial chemicals. In this implementation, excess energy generated by the nuclear reactor 102—which may otherwise be released as heat—can be harvested by the gas sequestration subsystem 130 to generate these secondary products. In particular, the gas sequestration subsystem 130 can be configured to generate fuels and/or chemicals from reactants captured from air (e.g., water, nitrogen) at a location at which the system 100 is deployed. The gas sequestration subsystem 130 can include a storage module configured to store fuels and/or chemicals generated at the location. These products can be collected at a particular frequency to minimize emissions output during travel to and from the location. Further, by generating these products autonomously from reactants found in air, the gas sequestration subsystem 130 can eliminate and/or minimize delivery (e.g., via truck) of supplies (i.e., reactants) to this location, thereby limiting emissions output during deliveries to the location.

For example, the system 100 can include a gas sequestration subsystem 130 configured to generate hydrogen for fueling hydrogen vehicles. In this example, the gas sequestration subsystem 130 can include: a set of hydrogen fueling units installed at the charging station 110; a water tank for storing water (e.g., collected from the air); and an electrolytic hydrogen generator for converting water and electricity into hydrogen. Further, the system 100 can include an inline heat exchanger configured to preheat water before reacting in the electrolytic hydrogen converter, thereby increasing efficiency of the electrolytic hydrogen converter and reducing electricity demand for the gas sequestration subsystem 130 in order to generate hydrogen. In this example, by including the gas sequestration subsystem 130, the system 100 can be configured to support both electric and hydrogen vehicles via a single nuclear reactor 102.

In another example, the system 100 can include a gas sequestration subsystem 130 configured to generate ammonia. In this example, the gas sequestration subsystem 130 can include: a device for capturing water and nitrogen from the air; an electrochemical ammonia generator; and a storage tank for storing ammonia generated by the gas sequestration subsystem 130.

In another implementation, the system 100 can include a gas sequestration subsystem 130 configured to enable carbon sequestration from air. In this implementation, the gas sequestration subsystem 130 be configured to: capture ambient air including carbon dioxide from a surrounding environment; separate carbon dioxide from other components of air (e.g., nitrogen, oxygen, hydrogen); and store captured carbon dioxide. By including the gas sequestration subsystem 130 configured to enable carbon sequestration, the system 100 can operate as a carbon-negative process.

### 7. Semi-Permanent Deployment

In one implementation, the system 100 can be semi-permanently deployed to a particular location. For example, the system 100 can be constructed—according to the techniques described above—at a first location for charging electric vehicles.

In this implementation, the system 100 can be configured to include a set of nuclear reactors 102 102, such that the system 100 can continuously operate during refueling of a particular nuclear reactor 102 in the set of nuclear reactors 102 102. For example, the system 100 can be constructed to include a pair of nuclear reactors 102 102 semi-buried in a single tunnel. A first nuclear reactor 102, in the pair of nuclear reactors 102 102, can be configured to continuously operate for a set duration (e.g., 10 years) over a first period of time beginning at a first time immediately following construction of the system 100. A second nuclear reactor 102, in the pair of nuclear reactors 102 102, can be configured to continuously operate for the set duration over a second period of time beginning at a second time succeeding the first time, the second period of time overlapping the first period of time. Upon expiration of the first period, the first nuclear reactor 102 can be collected for refueling, during which the second nuclear reactor 102 can continue to operate, thereby enabling continuous access to nuclear power for charging and limiting reductions in nuclear power availability.

In another example, the system 100 can include: a first modular nuclear reactor 102, in a set of modular nuclear reactors 102, loaded with a first core assembly and installed within a housing at a target location (e.g., proximal a major roadway); a second modular nuclear reactor 102, in the set of modular nuclear reactors 102, loaded with a second core assembly and installed within the housing at the target location; and a charging station coupled to the set of modular nuclear reactors 102 and configured to supply electrical power generated by the set of modular nuclear reactors 102 to electric vehicles transiently coupled to the charging station.

In this example, the system 100 can: trigger activation of the first modular nuclear reactor 102 during a first startup period; maintain deactivation of the second modular nuclear reactor 102 during the first startup period; regulate the operating capacity of the modular nuclear reactor 102 during a first live period succeeding the first startup period; and track a power output of the modular nuclear reactor 102 during the first live period. Then, in response to the power output of the first modular nuclear reactor 102 falling below a threshold power output during the first live period, the system 100 can: flag the first modular nuclear reactor 102 for replacement of the first core assembly; and automatically trigger activation of the second modular nuclear reactor 102 during a second startup period for the second modular nuclear reactor 102. Thus, during the cool-down period for the first modular nuclear reactor 102 and during replacement of the first core assembly within the first modular nuclear reactor 102, the system 100 can continue to supply electrical power to the charging station by activating the second modular nuclear reactor 102 in replacement of the first modular nuclear reactor 102.

### 7.1 Variation: Low-Population Density Deployment

In one variation, the system 100 can be semi-permanently deployed to a remote location with a low-population density. In this variation, because access to the power grid may be minimal or obsolete, the system 100 can be configured to automatically adjust direction of excess power output by the nuclear reactor 102 to the gas sequestration subsystem 130.

For example, the system 100 can be semi-permanently deployed to a remote location (e.g., in a desert)—defining a low-population density—proximal a major road (e.g., an interstate highway) to enable charging of electric vehicles travelling through and/or near the remote location via the major road.

The system 100 can initially be deployed and constructed according to the techniques described above. Once the nuclear reactor 102 is installed within the tunnel, the system 100 can trigger activation of the nuclear reactor 102. This initial setup period can be completed in approximately three days. Then, once the nuclear reactor 102 is activated, the system 100 can continuously operate the nuclear reactor 102 over an operating period of approximately ten years. At an end of this operating period, the system 100 can trigger deactivation of the nuclear reactor 102. Once the nuclear reactor 102 has cooled and emitted any remaining gamma radiation (e.g., within approximately one week of deactivating the nuclear reactor 102), the nuclear reactor 102 can be removed from the tunnel and returned to a processing facility—distinct from the remote location—to replace the core assembly with a new core assembly. The nuclear reactor 102 can then be redeployed to the remote location and reinstalled in the tunnel. Once reinstalled, the system 100 can again trigger activation of the nuclear reactor 102 for another operating period of approximately ten years.

In this example, the system 100—with limited or no access to the grid—can be configured to minimize energy losses while leveraging excess power to generate and/or capture secondary products. In particular, the system 100 can be configured to direct excess energy to the gas sequestration subsystem 130 for generating clean, valuable, secondary products.

### 7.2 Variation: High-Population Density Deployment

In one variation, the system 100 can be semi-permanently deployed to a high-population density region. For example, the system 100 can be deployed to a gas station located in downtown San Francisco. To reduce construction costs, the nuclear reactor 102 can be installed within a pre-existing structure (e.g., a car wash building) at the gas station. To complete installation of the charging station 110, an owner of the gas station can simply install a set of charging units 112 and a battery pack.

In this example, the charging station 110 may experience a high-volume of traffic during the day and a low-volume of traffic at night. More specifically, the system 100 charging station 110 may experience: a first period of high-volume traffic during the morning commute (e.g., between 6:00 AM and 10:00 AM); a second period of moderate-volume traffic during the middle of the day (e.g., between 10:00 AM and 3:00 PM); a third period of high-volume of traffic during the evening commute (e.g., between 3:00 PM and 8:00 PM); and a fourth period of low-volume traffic during the night (e.g., between 8:00 PM and 6:00 AM). To accommodate for periods of high-volume traffic, the system 100 can operate the nuclear reactor 102 at a maximum capacity during these periods. Further, the system 100 can direct energy generated during periods of low-volume traffic to the battery pack for storage. The system 100 can then leverage this stored energy to surge capacity of the nuclear reactor 102 during future periods of high-volume traffic.

Additionally and/or alternatively, the system 100 can direct excess power generated by the nuclear reactor 102 to the power grid. In the preceding example, the owner of the gas station can sell excess power generated by the nuclear reactor 102 during periods of low-volume traffic to the power grid, thereby offsetting costs of installing the system 100 at the gas station, lowering energy costs, and increasing availability of clean energy to the power grid.

### 8. Transient Deployment

In one variation, the system 100 can be configured for transient deployment to a particular location for a set duration. For example, the system 100 can be deployed in a stadium parking lot to temporarily provide additional power during a professional sporting event; deployed during disaster relief to supply power in locations with damaged infrastructure; or deployed to a business conference to provide clean power for a duration of the business conference.

In one example, the system 100 can be deployed to a geographic location proximal a 4-day outdoor festival (e.g., a music festival, an art festival), supplying clean power to the music festival over the particular duration. The system 100 can enable rapid, electric charging of electric vehicles driven to the music festival, thus encouraging electric-powered transportation and potentially reducing carbon emissions due to a decrease in carbon-fueled vehicles travelling to the musical festival. Further, the system 100 can supply excess power generated by the nuclear reactor 102 to provide additional power during the music festival.

In this example, the system 100 can be constructed prior to a first day of the music festival. In particular, if the first day of the music festival is a Thursday, a tunnel can be constructed—according to the methods described above—approximately five days prior the first day of the music festival, or the preceding Saturday. On Sunday, a concrete pad (i.e., a parking lot) can be poured for constructing the charging station no. By Monday, a battery pack and a set of vehicle charging units 112 can be installed about the concrete pad for electric vehicle charging. The nuclear reactor 102 can then be installed in the tunnel. Once complete, the system 100 can activate the nuclear reactor 102. The nuclear reactor 102 can be activated before the first day of the music festival to charge additional batteries in preparation for high-energy demand during the music festival.

During the music festival, the system 100 can operate the nuclear reactor 102 at maximum capacity to meet power demands. The system 100 can be configured to supply power to the charging station no according to charging demand, while directing any excess power generated by the nuclear reactor 102 to power the musical festival (e.g., concert lighting, sound system).

When the music festival ends, the system 100 can trigger deactivation of the nuclear reactor 102. However, the nuclear reactor 102 can continue generating heat over a cool-down period. During this cool-down period, to minimize damage to the nuclear reactor 102, the nuclear reactor 102 can be left at the location of the music festival while cooling down. Further, the system 100 can direct heat generated by the nuclear reactor 102 during the cool-down period to the gas sequestration subsystem 130. To reduce a carbon footprint of the music festival, the gas sequestration subsystem 130 can be configured to capture and store carbon dioxide from ambient air at this location. Therefore, the system 100 can offset an environmental impact of attendees driving gasoline powered vehicles to the music festival and/or consumption of coal-powered energy during the music festival.

Once the cool-down period is complete, the nuclear reactor 102 can be removed from the tunnel and deployed to a next location for a next event. Alternatively, the nuclear reactor 102 can be returned to a semi-permanent location. For example, a first unit of the system 100 installed at a semi-permanent location can include a set of nuclear reactors 102 102. In preparation for the music festival, a first nuclear reactor 102, in the set of nuclear reactors 102 102, can be deployed from the semi-permanent location to the location of the music festival for incorporation with a second unit of the system 100.

As a person skilled in the art will recognize from the previous detailed description and from the figures and claims, modifications and changes can be made to the embodiments of the invention without departing from the scope of this invention as defined in the following claims.

I claim:

1. A method for deploying a nuclear reactor system comprising:
during a first installation period:
at a processing facility, loading a modular nuclear reactor with a first core assembly, in a set of core assemblies, the modular nuclear reactor configured to receive replacement core assemblies over time;
at a first target location remote from the processing facility, constructing a housing configured to receive the modular nuclear reactor; and
installing the modular nuclear reactor, loaded with the first core assembly, within the housing at the first target location;
during a first startup period succeeding the first installation period:
triggering activation of the modular nuclear reactor; and
in response to triggering activation of the modular nuclear reactor:
tracking a temperature of the first core assembly;
tracking an operating capacity of the modular nuclear reactor; and
in response to the temperature exceeding a target setup temperature and the operating capacity exceeding a threshold operating capacity, confirming activation of the modular nuclear reactor;
during a first live period succeeding the first startup period, in response to confirming activation of the modular nuclear reactor:
regulating the operating capacity of the modular nuclear reactor within a target operating capacity range based on demand for energy generated by the modular nuclear reactor;
distributing electrical energy generated by the modular nuclear reactor to an energy supply coupled to the modular nuclear reactor; and
in response to the operating capacity falling below the threshold operating capacity, flagging the modular nuclear reactor for replacement of the first core assembly; and
during a first cool-down period, in response to flagging the modular nuclear reactor for replacement of the first core assembly:
triggering deactivation of the modular nuclear reactor; and
in response to triggering deactivation of the modular nuclear reactor:
tracking the temperature of the first core assembly;
tracking a neutron flux of the modular nuclear reactor; and
in response to the temperature falling below a target cool-down temperature, and in response to the neutron flux falling below a target cool-down flux, confirming deactivation of the modular nuclear reactor.

2. The method of claim 1, further comprising:
during a first interim period succeeding the first cool-down period, in response to confirming deactivation of the modular nuclear reactor:
removing the modular nuclear reactor, loaded with the first core assembly, from the housing;
transporting the modular nuclear reactor from the first target location to the processing facility; and
at the processing facility, removing the first core assembly from the modular nuclear reactor; and
during a second installation period succeeding the first interim period, loading the modular nuclear reactor with a second core assembly, in the set of core assemblies, in replacement of the first core assembly.

3. The method of claim 2, further comprising:
during the second installation period:
transporting the modular nuclear reactor, loaded with the second core assembly, from the processing facility to the first target location; and
installing the modular nuclear reactor, loaded with the second core assembly, within the housing at the first target location; and
during a second startup period succeeding the second installation period, triggering activation of the modular nuclear reactor.

4. The method of claim 2, further comprising, during the second installation period:
transporting the modular nuclear reactor, loaded with the second core assembly, from the processing facility to a second target location; and
installing the modular nuclear reactor, loaded with the second core assembly, within a second housing constructed at the second target location.

5. The method of claim 1:
wherein constructing the housing configured to receive the modular nuclear reactor comprises constructing the housing configured to receive the modular nuclear reactor proximal a roadway;
wherein installing the modular nuclear reactor within the housing at the first target location comprises installing the modular nuclear reactor within the housing proximal the roadway; and
further comprising, during the installation period:
installing a charging station at the first target location and comprising a set of charging units configured to receive electrical energy output by the modular nuclear reactor to transiently charge vehicles; and
installing an energy storage pack configured to store excess electrical energy output by the modular nuclear reactor.

6. The method of claim 5, further comprising:
constructing a second housing configured to receive a second modular nuclear reactor at a second target location proximal the roadway, the second target location separated from the first target location by a first travel distance within a range of travel distances;
installing a second charging station at the second target location and comprising a second set of charging units configured to receive electrical energy output by the second modular nuclear reactor to transiently charge vehicles;
installing a second energy storage pack at the second target location and configured to store excess electrical energy output by the second modular nuclear reactor; and
installing the second modular nuclear reactor within the second housing at the second target location to form a network of modular nuclear reactors comprising the first modular nuclear reactor and the second modular nuclear reactor.

7. The method of claim 1:
wherein constructing the housing configured to receive the modular nuclear reactor comprises constructing a tunnel configured to receive the modular nuclear reactor; and
further comprising, constructing a set of barriers proximal the tunnel and configured to restrict access into the tunnel.

8. The method of claim 1, further comprising, during the first live period:
monitoring security of the modular nuclear reactor via a set of sensors installed proximal the housing and configured to detect motion within a region containing the modular nuclear reactor; and
in response to detecting motion within the region:
triggering deactivation of the modular nuclear reactor;
flagging the modular nuclear reactor for further investigation;
generating a notification indicating detection of motion proximal the modular nuclear reactor; and
transmitting the notification to a user associated with the modular nuclear reactor.

9. The method of claim 1, wherein regulating the operating capacity within the target operating capacity range based on demand for energy generated by the modular nuclear reactor comprises:
during a high-demand period within the live period, triggering operation of the modular nuclear reactor at a first operating capacity within the target operating capacity range; and
during a low-demand period within the live period, triggering operation of the modular nuclear reactor at a second operating capacity less than the first operating capacity within the target operating capacity range.

10. The method of claim 1, further comprising, during the first live period:
accessing a first timeseries demand data representing demand for electrical energy supplied by the modular nuclear reactor during the first live period; and
wherein distributing electrical energy generated by the modular nuclear reactor to the energy supply comprises distributing electrical energy generated by the modular nuclear reactor between a primary energy supply and a secondary energy supply based on the first timeseries demand data.

11. The method of claim 10, wherein distributing electrical energy generated by the modular nuclear reactor between the primary energy supply and the secondary energy supply comprises:
identifying high-demand periods and low-demand periods during the first live period based on the first timeseries demand data; and
in response to identifying a first high-demand period during the first live period:
distributing a first portion of electrical energy generated by the modular nuclear reactor to a primary energy supply; and
distributing a second portion of electrical energy generated by the modular nuclear reactor to a secondary energy supply configured to receive excess energy generated by the modular nuclear reactor.

12. The method of claim 11, further comprising, in response identifying a first low-demand period during the first live period:
distributing a third portion of electrical energy generated by the modular nuclear reactor to the primary energy supply, the third portion less than the first portion of electrical energy; and
distributing a fourth portion of electrical energy generated by the modular nuclear reactor to the secondary energy supply, the fourth portion greater than the third portion of electrical energy.

13. The method of claim 12:
wherein directing the third portion of energy generated by the modular nuclear reactor to the secondary energy supply comprises directing the third portion of energy generated by the modular nuclear reactor to the secondary energy supply comprising a gas sequestration subsystem; and
wherein directing the fourth portion of energy generated by the modular nuclear reactor to the secondary energy supply comprises directing the fourth portion of energy generated by the modular nuclear reactor to the gas sequestration subsystem.

14. The method of claim 12:
wherein directing the third portion of energy generated by the modular nuclear reactor to the secondary energy supply comprises directing the third portion of energy generated by the modular nuclear reactor to the secondary energy supply comprising an electrical grid; and
wherein directing the fourth portion of energy generated by the modular nuclear reactor to the secondary energy supply comprises directing the fourth portion of energy generated by the modular nuclear reactor to the electrical grid.

15. The method of claim 1:
wherein confirming activation of the modular nuclear reactor in response to the temperature exceeding the target setup temperature and the operating capacity exceeding a threshold operating capacity comprises confirming activation of the modular nuclear reactor in response to the temperature exceeding the target setup temperature and the operating capacity exceeding the threshold operating capacity of thirty percent; and
wherein flagging the modular nuclear reactor for replacement of the first core assembly in response to the operating capacity falling below the threshold operating capacity comprises flagging the modular nuclear reactor for replacement of the first core assembly in response to the operating capacity falling below the threshold operating capacity of thirty percent.

16. The method of claim 1:
wherein loading the modular nuclear reactor with the first core assembly comprises loading a first modular nuclear reactor with the first core assembly;
wherein constructing the housing configured to receive the modular nuclear reactor comprises constructing the housing configured to receive the first modular nuclear reactor and a second modular nuclear reactor;
wherein installing the modular nuclear reactor, loaded with the first core assembly, within the housing at the first target location comprises installing the first modular nuclear reactor, loaded with the first core assembly, within the housing at the first target location;
wherein triggering activation of the modular nuclear reactor during the first startup period comprises triggering activation of the first modular nuclear reactor during the first startup period;
wherein regulating the operating capacity of the modular nuclear reactor during the first live period comprises regulating the operating capacity of the first modular nuclear reactor during the first live period;
wherein flagging the modular nuclear reactor for replacement of the first core assembly during the first live period comprises flagging the first modular nuclear reactor for replacement of the first core assembly during the first live period;
wherein triggering deactivation of the modular nuclear reactor during the first cool-down period comprises triggering deactivation of the first modular nuclear reactor during the first cool-down period;
wherein confirming deactivation of the modular nuclear reactor during the first cool-down period comprises confirming deactivation of the first modular nuclear reactor during the first cool-down period; and
further comprising, during the first installation period:
at the processing facility, loading a second modular nuclear reactor with a second core assembly, in the set of core assemblies, the second modular nuclear reactor configured to receive replacement core assemblies over time;
installing the second modular nuclear reactor, loaded with the second core assembly, within the housing at the first target location; and
during the first cool-down period, in response to flagging the modular nuclear reactor for replacement of the first core assembly, triggering activation of the second modular nuclear reactor.

17. The method of claim 1, further comprising, during the first cooldown period, directing energy generated by the modular nuclear reactor to a gas sequestration subsystem coupled to the modular nuclear reactor and configured to:
receive energy output by the nuclear reactor; and
capture secondary gases comprising carbon dioxide from atmospheric air at the first target location.

18. A method for deploying a nuclear reactor system comprising:
during an installation period:
constructing a tunnel configured to receive a modular nuclear reactor at a particular location; and
installing the modular nuclear reactor including a first core assembly within the tunnel; and
during a first operating period succeeding the installation period and defining a target duration:
in response to detecting a high-energy demand period:
triggering operation of the modular nuclear reactor at a first capacity;
directing a first portion of energy output to a charging station for charging electric vehicles; and
directing a second portion of energy output to a gas sequestration subsystem, the second portion less than the first position; and
in response to detecting a low-energy demand period:
triggering operation of the modular nuclear reactor at a second capacity less than the first capacity;
directing a third portion of energy output to the charging station, the third portion less than the first portion; and
directing a fourth portion of energy output to the gas sequestration subsystem, the fourth portion greater than the second portion.

19. The method of claim 18, further comprising, in response to expiration of the target duration:
triggering deactivation of the modular nuclear reactor;
transferring the modular nuclear reactor from the tunnel at the first location to a processing facility at a secondary location, distinct from the first location, for replacement of the first core assembly with a second core assembly; and
during a second installation period succeeding the first operating period, reinstalling the modular nuclear reactor, loaded with the second core assembly, in the tunnel.

20. The method of claim 19, wherein triggering deactivation of the modular nuclear reactor in response to expiration of the target duration comprises triggering deactivation of the modular nuclear reactor in response to expiration of the target duration comprising a duration between five years and ten years.
